(19) United States
(12) Patent Application Publication
(10) Pub. No.: US 2015/0053604 A1
(43) Pub. Date: Feb. 26, 2015

(54) System and Method for Filtering a Metal Trough

(71) Applicants: Benjamin Lev Kweller, Austin, TX (US); Elizabeth Kweller, Austin, TX (US)

(72) Inventors: Benjamin Lev Kweller, Austin, TX (US); Elizabeth Kweller, Austin, TX (US)

(21) Appl. No.: 13/974,049

(22) Filed: Aug. 23, 2013

(51) Int. Cl. C02F 1/00; G05D 7/00

(52) U.S. Cl. CPC C02F 1/004; G05D 7/00; A01K 39/02
USPC 210/416.1; 137/1

(57) ABSTRACT

This disclosure relates to a filtered metal trough. A filtered metal trough can have various uses. A filtered metal trough can be used as a stylish aboveground swimming pool. Such pool is rugged, compact, requires little maintenance, and is durable. A filtered metal trough can also be used as clean, healthy alternative to a standard metal trough for watering animals. In particular, this disclosure describes a filtered metal trough comprising a trough comprising an intake orifice and a discharge orifice, a water pump, and a water filter. Additionally, such filtered metal trough can comprise an intake hose that connects the trough intake orifice to the water pump, an intermediary hose that connects the water pump to the water filter, and a discharge hose that connects the water filter to the discharge orifice.

### BACKGROUND

This disclosure relates to a system and method for filtering a metal trough.

Most people would love to and enjoy having their own pool for swimming and other water activities. However, many people cannot afford or do not have the space for a full size in-ground fiberglass pool as it can be very expensive. Further, installation and upkeep maintenance of such pool can be very costly as well. As such, aboveground pools were developed. An aboveground pool can be less expensive; however, the parts associated with the aboveground pool are not as durable as the other pool options available on the market, and if not maintained properly, can deteriorate quickly. For example, a vinyl-lined pool has to be replaced every few years since the appearance of the pool structure deteriorates over time.

Further, unrelated to pools, when watering many animals, a rancher can place large metal troughs containing water, outside for the animals A large trough can hold hundreds or even thousands of gallons of water, and can last for long periods of time depending on the number of livestock drinking from the pool. During this time, problems can arise. First, stagnant water can be a breeding ground for mosquitos. Mosquitos can transmit illnesses that can be harmful to human and livestock. Second, stagnant water can is capable of harboring disease and transferring it between animals.

As such it would be useful to have an improved system and method for filtering a metal trough.

### SUMMARY

This disclosure relates to a filtered metal trough. A filtered metal trough can have various uses. A filtered metal trough can be used as a stylish aboveground swimming pool. Such pool is rugged, compact, requires little maintenance, and is durable. A filtered metal trough can also be used as clean, healthy alternative to a standard metal trough for watering animals.

In particular, this disclosure describes a filtered metal trough comprising a trough comprising an intake orifice and a discharge orifice, a water pump, and a water filter. Additionally, such filtered metal trough can comprise an intake hose that connects the trough intake orifice to the water pump, an intermediary hose that connects the water pump to the water filter, and a discharge hose that connects the water filter to the discharge orifice.

This disclosure further describes a method of providing clean water to livestock. In particular, the method comprises the step of filling a metal trough with water, wherein said metal trough comprises a base and a one or more thin walls, further wherein said trough comprises an intake orifice and a discharge orifice. The method further includes the step of cycling the water as follows: from said trough, through said intake orifice, to an intake hose; through said intake hose, to a first water-handling device; through said water handling device, to an intermediary hose; through said intermediate hose, to a second water handling device; through said second water-handling device, to a discharge hose; through said discharge hose, to a discharge orifice; and through said discharge orifice, into said trough. The method also includes the step of providing said water in said trough to livestock for consumption. In such embodiment, a water-handling device can be a water pump or a water filter.

This disclosure further describes a method of providing clean recreational area for water activities. In particular, the method comprises the step of filling a metal trough with water, wherein said metal trough comprises a base and a one or more thin walls, further wherein said trough comprises an intake orifice and a discharge orifice. The method further includes the step of cycling the water as follows: from said trough, through said intake orifice, to an intake hose; through said intake hose, to a first water handling device; through said water handling device, to an intermediary hose; through said intermediate hose, to a second water handling device; through said second water handling device, to a discharge hose; through said discharge hose, to a discharge orifice; and through said discharge orifice, into said trough. The method also includes the step of providing said trough to one or more persons for water activities. In such embodiment, a water-handling device can be a water pump or a water filter.

### BRIEF DESCRIPTION OF THE DRAWINGS

FIG. 1 illustrates a filtered metal trough system.

FIG. 2 illustrates an intake port outer assembly.

FIG. 3 illustrates an intake port inner assembly.

FIG. 4 illustrates a discharge port outer assembly.

FIG. 5 illustrates a discharge port inner assembly.

### DETAILED DESCRIPTION

Described herein is a system and method for filtering a metal trough. The following description is presented to enable any person skilled in the art to make and use the invention as claimed and is provided in the context of the particular examples discussed below, variations of which will be readily apparent to those skilled in the art. In the interest of clarity, not all features of an actual implementation of a filtered metal trough are described in this specification. It will be appreciated that in the development of any such actual implementation (as in any project), design decisions must be made to achieve the manufacturer's specific goals (e.g., compliance with system and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

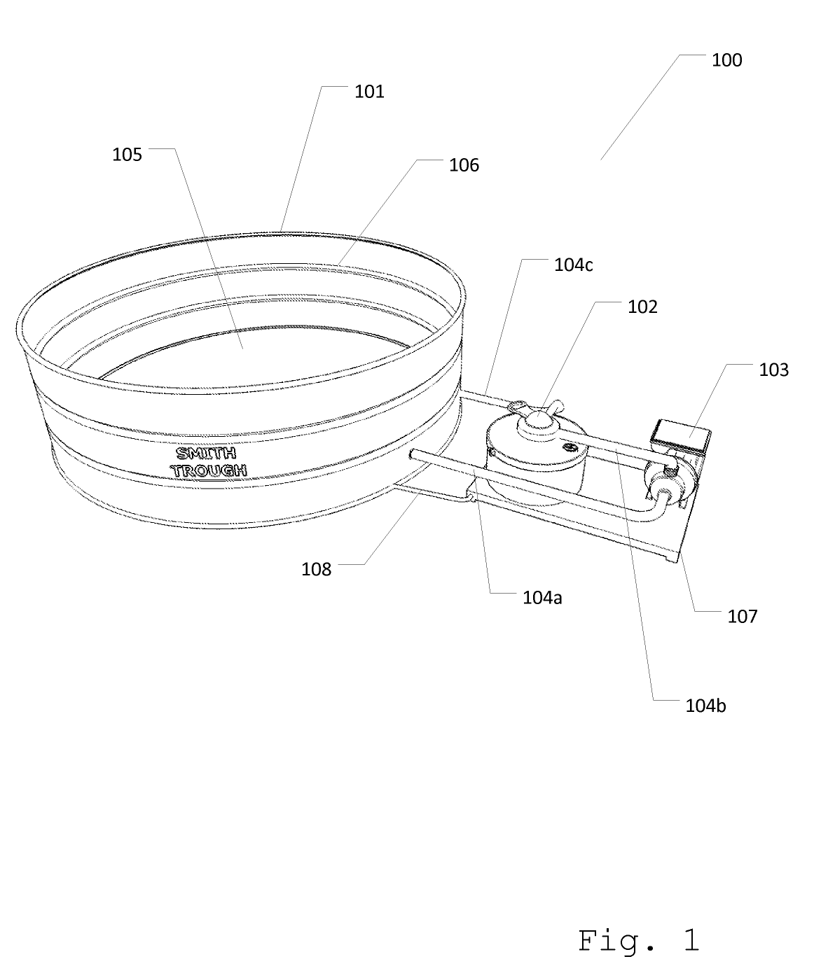

FIG. 1 illustrates a perspective view of a filtered metal trough system 100. Filtered metal trough system 100 can comprise of a trough 101, a water filter 102, and a water pump 103, all connected through various hoses 104. Trough 101 can comprise metal such as, but not limited to, steel, galvanized steel, iron, and/or copper. In one embodiment, trough 101 can consist only of metal. Trough can be round, oval, rectangular, square, or any other shape. The preferred embodiment for a trough is a round trough, as a round trough can hold the larger amounts of water using less material. Structurally, trough 101 comprises a floor 105 and walls 106 following the edge of floor 105, rising vertically. As metals are heavy, trough 101 structure will, in a preferred embodiment be thin, having wall 106 and floor 105 thickness each less than half of one centimeter.

Hoses 104 can comprise various materials, including but not limited to, metal, plastic, and/or rubber. In a preferred embodiment, hoses 104 are flexible. In one embodiment, as shown in FIG. 1, an intake hose 104a can connect trough 101 to water pump 103. An intermediary hose 104b can connect water pump 103 to water filter 102. Water filter 102 can filter water as it pass through. From water filter 102, filtered water can pass through a discharge hose 104c connecting water filter 102 to trough 101.

In another embodiment, intake hose 104a can connect trough 101 to water filter 102, second hose 104b can connect water filter 102 to water pump 103, and third hose 104c can connect water pump 103 to trough 101. In such embodiment water pump 102 can pull water through filter 102 and push filtered water into trough 101.

In one embodiment, filtered metal trough system can further comprise a ground plate 107 and/or a ground wire 108. In such embodiment, water filter 102 and water pump 103 can be electrically grounded to ground plate. In such configuration, ground plate can also provide structural support for water filter 102 and water pump 103, keeping both off the ground surface. In such embodiment, ground wire 108 can connect trough 101 to ground plate 107, effectively grounding trough 101. In another embodiment, ground wire can connect trough 101 directly to water pump 103 and/or water filter 102.

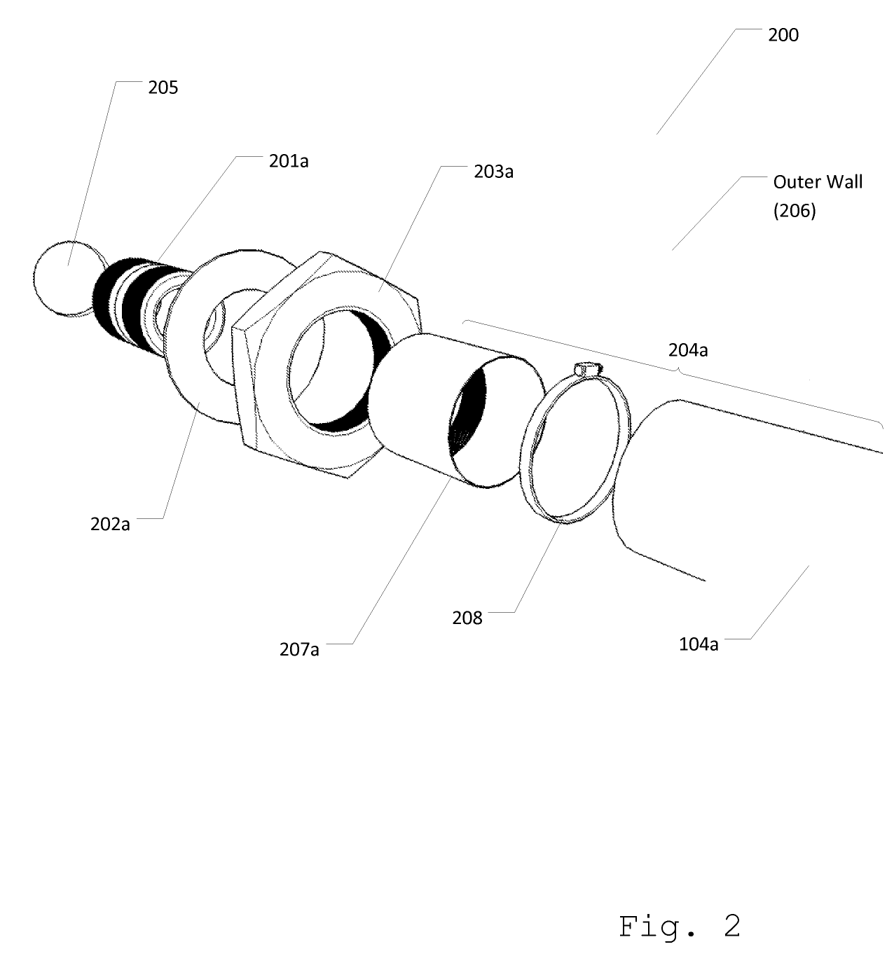

FIG. 2 illustrates an outer view of an intake port assembly 200. Intake port assembly 200 can comprise a male-male threaded conduit 201a, a washer 202a, an outer threaded cap 203a, and a transition assembly 204a. Male-male threaded conduit 201a can pass partially through an intake orifice 205 of trough 101. Washer 202a can then pass around threaded conduit 201 a and rest against outer wall 206 of trough 101. In a preferred embodiment, washers 202 comprise a compressible material such as rubber. Outer thread cap 203a can then screw onto threaded conduit 201a, pressing washer 202a against outer wall 206. Transition assembly 204a can connect threaded conduit 201a to intake hose 104a. In one embodiment, as shown in FIG. 2, transition assembly 204a can comprise a transition conduit 207a and a jubilee clip 208. In such embodiment, threaded conduit 201 a can connect to transition conduit 207a on one end, and intake hose 104a can push around transition conduit 207a on it other end. To keep intake hose 104a in position, jubilee clip 208 can be placed around intake hose 104a. It should be recognized that specific components such as transition assembly 204a and outer thread cap 203a can be combined into one component. Additionally, in another embodiment, threaded conduit 207a can be threaded on a portion residing inside trough 101 and immediately outside trough 101, but unthreaded on an end port that is outside trough 101. In such embodiment, outer thread cap 203a can screw onto threaded conduit 207a, and intake hose 104a can connect directly to threaded conduit, over the unthreaded portion.

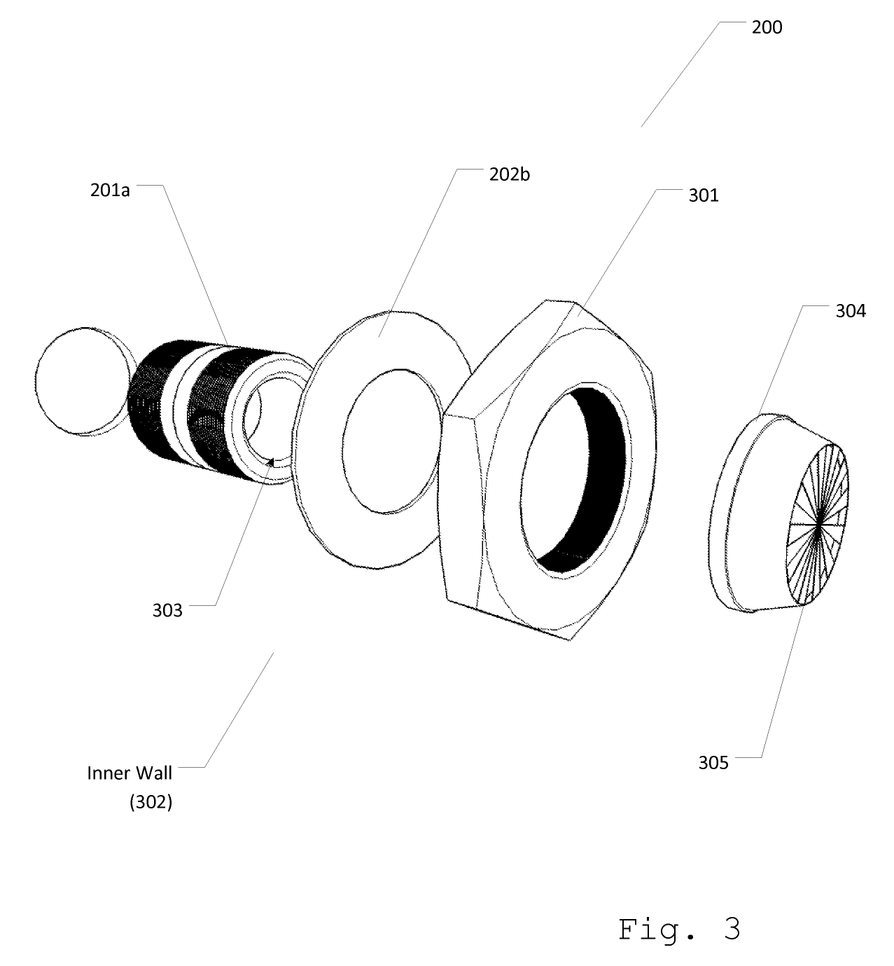

FIG. 3 illustrates an inner view of an intake port assembly 200. Intake port assembly 200 can further include a second washer 202b and a threaded intake cap 301. Washer 202b can pass around threaded conduit 201a at the inside of trough 101. Threaded intake cap 301 can screw on to threaded conduit 201a, pressing washer 202b against an inner wall 302 of trough 101. Threaded intake cap 301 can, in one embodiment, cover a portion of a threaded conduit opening 303. Threaded intake cap 301 can comprise a cap orifice 304 for water to pass through, and in one embodiment, threaded intake cap 301 can comprise a grill 305 within cap orifice 304. Grill 305 can prevent large particles from entering intake hose 104a, potentially damaging water pump 203 or water filter 202.

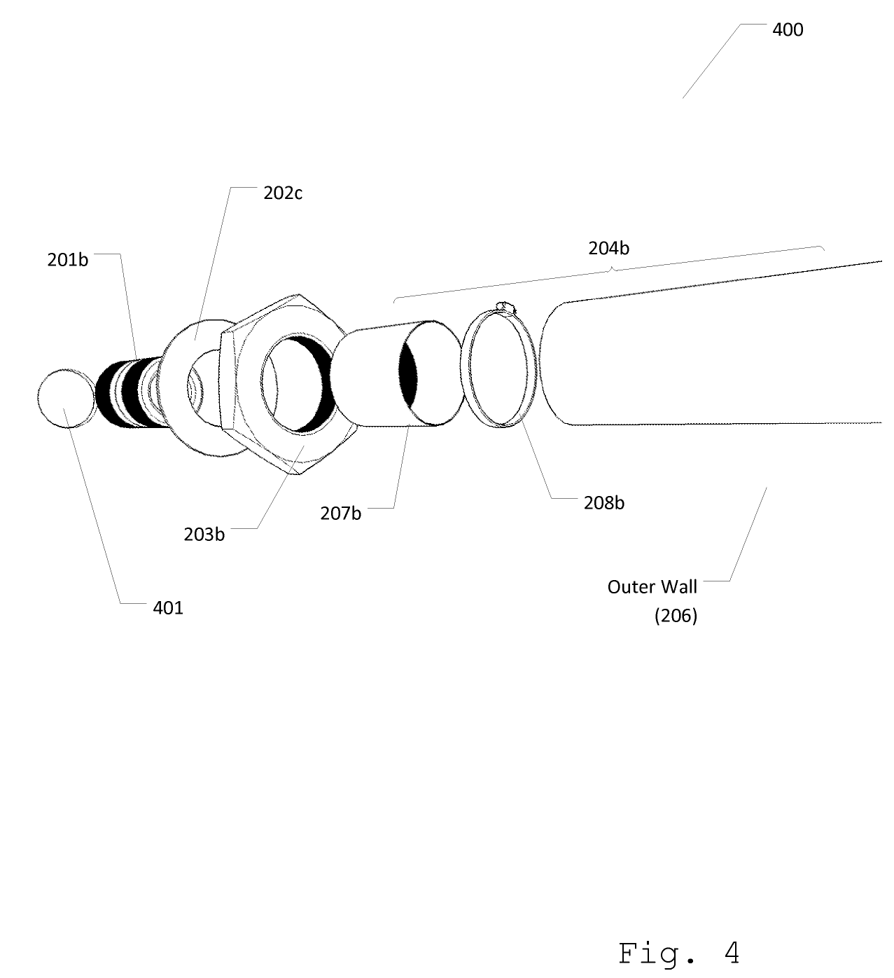

FIG. 4 illustrates an outer view of a discharge port assembly 400. Discharge port assembly 400 can be similar to intake port assembly 200. Discharge port assembly 400 can comprise a male-male threaded conduit 201b, a washer 202c, an outer threaded cap 203b, and a transition assembly 204b. Male-male threaded conduit 201b can pass partially through a discharge orifice 401 of trough 101. Washer 202c can then pass around threaded conduit 201b and rest against outer wall 206 of trough 101. Outer thread cap 203b can then screw onto threaded conduit 201b, pressing washer 202b against outer wall 206. Transition assembly 204b can connect threaded conduit 201b to discharge hose 104c. In one embodiment, as shown in FIG. 2, transition assembly 204b can comprise a transition conduit 207b and a jubilee clip 208b. In such embodiment, threaded conduit 201a can connect to transition conduit 207b on one end, and intake hose 104a can push around transition conduit 207b on it other end. To keep discharge hose 104c in position, jubilee clip 208b can be placed around discharge hose 104c. It should be recognized that specific components such as transition assembly 204c and outer thread cap 203c can be combined into one component. Additionally, in another embodiment, threaded conduit 207b can be threaded on a portion residing inside trough 101 and immediately outside trough 101, but unthreaded on an end port that is outside trough 101. In such embodiment, outer thread cap can screw onto threaded conduit 207a, and discharge hose 104c can connect directly to threaded conduit 207b, over the unthreaded portion.

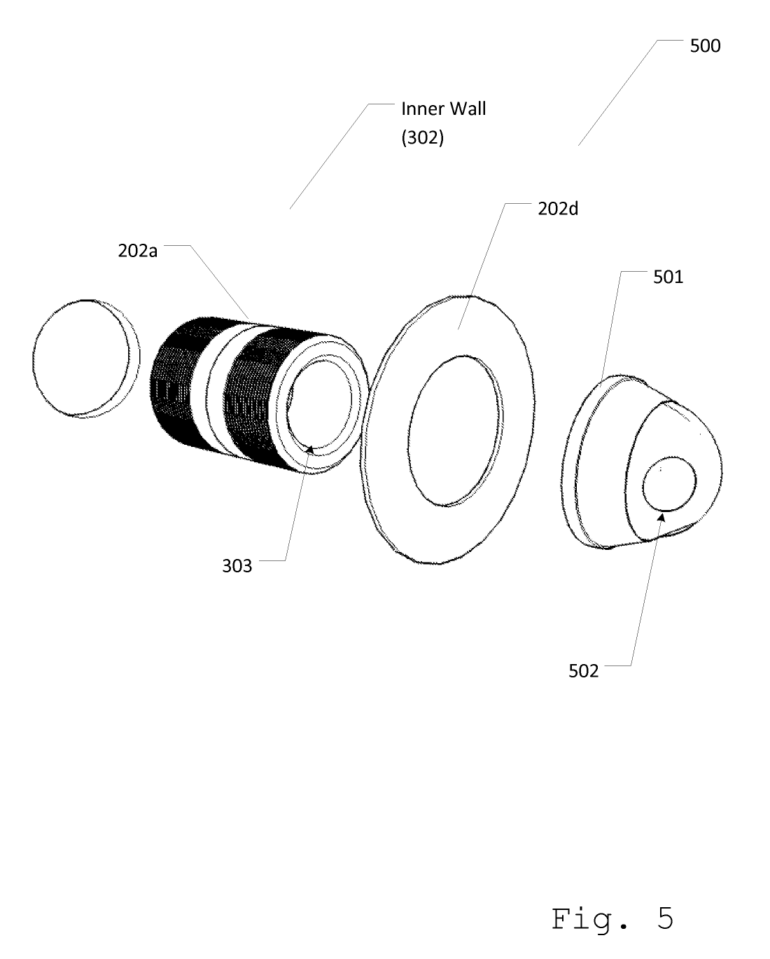

FIG. 5 illustrates an inner view of a discharge port assembly 500. Discharge port assembly 500 can further include a fourth washer 202d and a threaded discharge cap 501. Washer 202d can pass around threaded conduit 201 a at the inside of trough 101. Threaded discharge cap 501 can screw on to threaded conduit 201a, pressing washer 202d against an inner wall 302 of trough 101. Threaded discharge cap 501 can, in one embodiment, cover a portion of a threaded conduit opening 303. Threaded discharge cap 501 can comprise a discharge orifice 502 for water to pass through. In one embodiment, discharge orifice 502 can be directional. Further, in one embodiment, discharge orifice 502 can be rotatable. By discharging water in a direction along the direction of trough wall, water within trough 101 will swirl.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A filtered metal trough comprising
a metal trough comprising an intake orifice and a discharge orifice,
a water pump,
a water filter,
an intake hose that connects said trough intake orifice to said water pump,
an intermediary hose that connects said water pump to said water filter, and
a discharge hose that connects said water filter to said discharge orifice.

2. The filtered metal trough of claim 1, further wherein said trough is a cylinder.

3. The filtered metal trough of claim 1, further comprising
an intake port assembly that connects intake hose to said intake orifice; and
a discharge port assembly that connects said discharge hose to discharge orifice.

4. The filtered metal trough of claim 3 wherein said intake port assembly comprises
a first threaded conduit placed within said intake orifice;
a first washer around said first threaded conduit inside trough; and
a threaded intake cap connected to said first threaded conduit inside trough,
wherein said threaded intake cap comprises a cap orifice.

5. The filtered metal trough of claim 4 wherein said first threaded intake cap comprises a grill.

6. The filtered metal trough of claim 5 wherein said intake port assembly further comprises
a second washer around said first threaded conduit outside trough;
an outer thread cap around said conduit capable of compressing said second washer against the outside of said trough;

7. The filtered metal trough of claim 6 further comprising a transition assembly that connects said intake hose to said threaded conduit.

8. The filtered metal trough of claim 7 further comprising a jubilee clip mounted around said hose fitted on said transition assembly.

9. The filtered metal trough of claim 3 wherein said discharge port assembly comprises
a second threaded conduit placed within said discharge orifice;
a third washer around said second threaded conduit inside trough; and
a threaded discharge cap connected to said second threaded conduit inside trough.

10. The filtered metal trough of claim 4 wherein said first threaded discharge cap comprises a rotatable discharge orifice.

11. The filtered metal trough of claim 1 further comprising a ground plate that is electrically connected to said water pump and said water filter.

12. The filtered metal trough of claim 9 further comprising a ground wire electrically connecting said trough to said water pump and said water filter.

13. A method of providing clean water to livestock, comprising
filling a metal trough with water, wherein said metal trough comprises a base and a one or more thin walls, wherein said trough comprises an intake orifice and a discharge orifice
cycling said water as follows:
from said trough, through said intake orifice, to an intake hose;
through said intake hose, to a first water handling device;
through said water handling device, to an intermediary hose;
through said intermediate hose, to a second water handling device;
through said second water handling device, to a discharge hose;
through said discharge hose, to a discharge orifice; and
through said discharge orifice, into said trough; and
providing said water in said trough to livestock for consumption.

14. The method of claim 13, wherein said first water handling device is a water pump.

15. The method of claim 14 wherein said second water handling device is a water filter.

16. The method of claim 13 wherein said first water handling device is a water filter.

17. The method of claim 16 wherein said second water handling device is a water pump.

18. A method of providing clean recreational area for water activities, comprising
filling a metal trough with water, wherein said metal trough comprises a base and a one or more thin walls, wherein said trough comprises an intake orifice and a discharge orifice
cycling said water as follows:
from said trough, through said intake orifice, to an intake hose;
through said intake hose, to a first water handling device;
through said water handling device, to an intermediary hose;
through said intermediate hose, to a second water handling device;
through said second water handling device, to a discharge hose;
through said discharge hose, to a discharge orifice; and
through said discharge orifice, into said trough; and
providing said trough to one or more persons for water activities.

19. The method of claim 18, wherein said metal trough is made of steel.

20. The method of claim 19, wherein said steel is galvanized.
